(19) United States
(12) Patent Application Publication
(10) Pub. No.: US 2017/0272811 A1
(43) Pub. Date: Sep. 21, 2017

(54) METHOD AND ELECTRONIC DEVICE FOR PROGRAM SWITCHING

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Xiaofei ZAN, Beijing (CN)

(21) Appl. No.: 15/247,021

(22) Filed: Aug. 25, 2016

Related U.S. Application Data
(63) Continuation of application No. PCT/CN2016/089043, filed on Jul. 7, 2016.

(30) Foreign Application Priority Data
Mar. 21, 2016 (CN) 201610162039.2

(51) Int. Cl. H04N 21/438; H04N 21/431; H04N 21/44; H04N 21/84

(52) U.S. Cl. CPC H04N 21/4383; H04N 21/84; H04N 21/4312; H04N 21/44008

(57) ABSTRACT

A method and an electronic device for program switching are disclosed. The method includes: loading a next program at a backend after a program switching instruction is received; obtaining a last frame of program image at a time when the program switching instruction is received and displaying the last frame of program image; obtaining program information about the next program and displaying the program information in the last frame of program image; obtaining a first frame of program image of the next program and switching and displaying the image as the first frame of program image; and starting to play the next program at a time when a content of the next program is completely loaded.

### CROSS-REFERENCE TO RELATED APPLICATIONS

This application is a continuation of International Application No. PCT/CN2016/089043, with an international filing date of Jul. 7, 2016, which is based upon and claims priority to Chinese Patent Application No. 201610162039.2, filed on Mar. 21, 2016, the entire contents of all of which are incorporated herein by reference.

### TECHNICAL FIELD

The present disclosure relates to the technical field of multimedia data processing, and in particular, to a method and an electronic device for program switching.

### BACKGROUND

Along with the constant development of modern technologies, smart equipment emerges one after another, network technologies also become more advanced, recreations and entertainments of people at present have become quite different from those in the past. For a home equipped with network, smart equipment is usually chosen to watch network programs.

In a television-end product of the prior art, an image either presents a black screen until a played content of a next program is displayed after the next program is completely loaded, or simply displays a loading ring on a black screen, in a process in which a channel switch operation is performed to stop a currently-played program content and to load the next program.

### SUMMARY

An embodiment of the present disclosure provides a method for program switching. The method includes:

at an electronic device:

loading a next program at a backend after a program switching instruction is received;

obtaining a last frame of program image at a time when the program switching instruction is received and displaying the last frame of program image;

obtaining program information about the next program and displaying the program information in the last frame of program image;

obtaining a first frame of program image of the next program and switching and displaying the image as the first frame of program image; and

starting to play the next program at a time when a content of the next program is completely loaded.

Another embodiment of the present disclosure provides an electronic device for searching videos, the device includes: electronic device. The electronic device includes:

at least one processor; and

a memory communicably connected with the at least one processor for storing instructions executable by the at least one processor, wherein execution of the instructions by the at least one processor causes the at least one processor to:

load a next program at a backend after a program switching instruction is received;

obtain a last frame of program image at a time when the program switching instruction is received and display the last frame of program image;

obtain program information about the next program and display the program information in the last frame of program image;

obtain a first frame of program image of the next program and switch and display the image as the first frame of program image; and

start to play the next program at a time when a content of the next program is completely loaded.

Still another embodiment of the present disclosure provides a non-transitory computer-readable storage medium. The non-transitory computer-readable storage medium stores executable instructions, wherein when the executable instructions are executed by an electronic device, causes the electronic device to:

load a next program at a backend after a program switching instruction is received;

obtain a last frame of program image at a time when the program switching instruction is received and display the last frame of program image;

obtain program information about the next program and display the program information in the last frame of program image;

obtain a first frame of program image of the next program and switch and display the image as the first frame of program image; and

start to play the next program at a time when a content of the next program is completely loaded.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow chart of a method for program switching according to an embodiment of the present disclosure;

FIG. 2 is a schematic flow chart of a method for program switching according to another embodiment of the present disclosure; and

FIG. 3 is a structural schematic diagram of modules of an apparatus for program switching according to an embodiment of the present disclosure.

FIG. 4 is a structural schematic diagram of modules of an electronic device for program switching according to another embodiment of the present disclosure.

### DETAILED DESCRIPTION

In order to make the objectives, technical solutions, and advantages of the present disclosure more clear, the present disclosure is further described in detail below through embodiments with reference to the accompanying drawings.

It should be noted that the expressions “first” and “second” used in the embodiment of the present disclosure are only for distinguishing two different entities having identical names or two different parameters, and therefore, the “first” and “second” are used only to make it convenient to describe, and cannot be understood as a limitation to the embodiment of the present disclosure, which is not described one by one again in the subsequent embodiments.

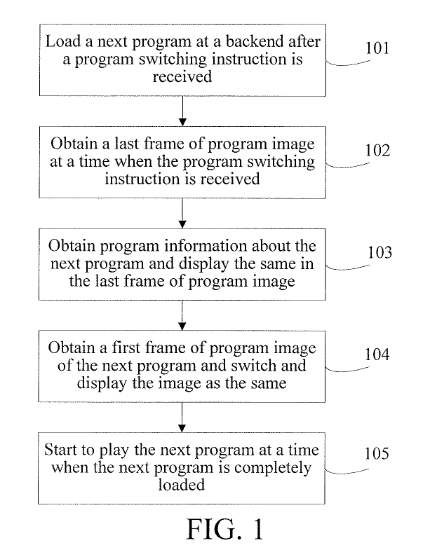

A first aspect of an embodiment of the present disclosure provides a method for program switching, capable of providing some pieces of relevant program information to a user during a program switch process so as to alleviate boring feelings of the user. As shown in FIG. 1, FIG. 1 a schematic flow chart of a method for program switching according to an embodiment of the present disclosure.

The method for program switching includes the following steps:

In step 101: Load a next program at a backend after a program switching instruction is received. That is, the process of loading the next program is not displayed to a user and the loading is only performed at the backend.

in step 102: Obtain a last frame of program image at a time when the program switching instruction is received and display the last frame of program image, so as first display the last frame of program image on a screen in freezing manner after the program switching instruction is received. The last frame of program image indicates a last frame of image that is currently played at a time point when the program switching instruction is received.

At this time, a loading progress ring may be optionally displayed in the last frame of program image while displaying the last frame of program image, so as to inform the user of that loading of the next program is currently in process, instead of an occurrence of screen crash.

In step 103: Obtain program information about the next program and display the program information in the last frame of program image.

The program information about the next program is further displayed on the screen to provide some information about the next program to the user. The program information includes a program name, a program brief program start and stop time points, and the like. The program information may be optionally displayed at an upper-right corner of the screen.

In step 104: Obtain a first frame of program image of the next program and switch and display the image as the first frame of program image.

After the first frame of program image of the next program is completely loaded, the image is switched and displayed as the first frame of program image, so as to provide an image preview of the next program to the user. At this time, the loading progress ring and the program information both may be remained, and only the last frame of program image is replaced.

In step 105: Start to play the next program at a time when a content of the next program is completely loaded.

When starting to play the next program, a playing window may be set to have a first priority, so as to enable the playing window to directly cover the several previously-displayed contents when being started to play. That is, the several previously-displayed contents are not deleted, and the playing window that is set to have the first priority covers and displays on the several previously-displayed contents when being started to play, so that only the playing window that starts to play the next program can be viewed in the visual effect. Alternatively, the playing window always exists, but has a priority lower than those of the several previously-displayed contents. Therefore, when playing of the next program can be started, the several previously-displayed contents are deleted and the playing window is displayed on the top layer again, so that the playing window can again be viewed in the visual effect and again start to play the next program.

As can be seen from the above embodiment, the method for program switching provided by an embodiment of the present disclosure, by gradually displaying a last frame of program image of a program before switching, program information about a next program, and a first frame of program image of the next program during a program switching and loading process, can form visual effects of image freezing during channel switch to display a loading ring (optional) and the program information about the next program, then display the first frame of program image of the next program, and remove the aforementioned images after playing starts, so that a user may not feel boring while waiting in a processing of loading the next program, but rather may obtain some pieces of brief information about the next program during the process of loading the program, and the channel switch experience of the user is improved. Meanwhile, by providing these pieces of brief information to the user timely and effectively, the user may further have a general understanding of whether the user is interested in the program according to these pieces of information, so as to again switch a channel without waiting until the program is loaded.

To enable displaying of the first frame of program image of the next program not to influence displaying of the last frame of program image, further, in some optional implementation manners, step 104 of obtaining a first frame of program image of the next program and switching and displaying the image as the first frame of program image further includes the following steps:

configuring a first frame of program image display floating layer of the next program on the last frame of program image;

processing the first frame of program image display floating layer to be transparent, where optionally a default background of the first frame of program image is set to be transparent by using GenericDraweeHierarchy of Fresco;

loading the first frame of program image into the first frame of program image display floating layer; and

gradually changing transparency of the first frame of program image display floating layer after the first frame of program image is completely loaded and finally displaying the first frame of program image, where optionally, the first frame of program image is set by the AbstractDraweeController to be displayed in a gradually changing manner after being successfully downloaded, to achieve a final effect, and besides, the last frame of program image may optionally be deleted before gradually displaying the first frame of program image.

Sometimes, under a poor network condition, the program loading process takes a long time. Therefore, in some optional implementation manners, after step 104 of obtaining a first frame of program image of the next program and switching and displaying the image as the first frame of program image, the method may further include the following steps:

determining whether the next program is completely loaded within a first preset threshold period of time, where the first preset threshold period of time may be set by default, or may also be defined by a user, for example, 1 min;

if the next program is not completely loaded within the first preset threshold period of time, obtaining multiple key frames of program images of the next program, where the key frame of program image may be preset by a server and can be obtained as long as a terminal sends a request to the server to obtain data returned by the server, and the key frames may be selected and obtained by intercepting program images at equal intervals, or may also be obtained through selection of special frames according to different program contents; and

sequentially displaying the multiple key frames of program images according to a first preset time interval, where the first preset time interval indicates a display time interval of the multiple key frames of program images, for example, switching to a next key frame of program image for every 2 s, and the first preset time interval may be set by default, or may also be defined by a user.

By setting a first preset threshold period of time, user experience can be improved by sequentially displaying multiple key frames of program images to a user for the user to have a general understanding of a next program, other than only view a first frame of program image of the next program under a poor network condition.

In some other optional implementation manners, after step 104 of obtaining a first frame of program image of the next program and switching and displaying the image as the first frame of program image, the method may further include the following steps:

determining whether the next program is completely loaded within a second preset threshold period of time, where the second preset threshold period of time may be set by default, or may also be defined by a user, the second preset threshold period of time may be the same as the first preset threshold period of time, for example, 1 min, and at this time the embodiment is a parallel technical solution of the previous embodiment; certainly, the second preset threshold period of time may also be different from the first preset threshold period of time, for example, 3 min; and when 3 min is reached, the steps in the embodiment are adopted;

if the next program is not completely loaded within the second preset threshold period of time, obtaining a program list of a television broadcast station in which the next program is located, where the program list shows a list of programs of the television broadcast station in which the next program is located, and the list includes some pieces of basic information about the programs, for example, playing time and to-be-played content;

sequentially obtaining, according to the program list, first frames of program images of multiple programs of the television broadcast station played after the next program; and

Sequentially displaying the first frames of program images of the multiple programs according to a second preset time interval, where optionally, the first frame of program image of each program may also display to-be-played content and playing time of the program.

By setting a second preset threshold period of time, under a poor network condition, in an implementation manner, when the second preset threshold period of time is the same as the first preset threshold period of time, user experience can be improved by sequentially displaying first frames of program images of multiple programs to a user for the user to have a general understanding of a subsequent playing plan of a television broadcast station in which a next program is located, other than only view a first frame of program image of the next program. In another implementation manner, when the second preset threshold period of time is different from the first preset threshold period of time, user experience can be improved by sequentially displaying first frames of program images of multiple programs to a user, after the second preset threshold period of time is reached, for the user to have a general understanding of a subsequent playing plan of a television broadcast station in which a next program is located.

Further, in some optional implementation mariners, the step of obtaining a program list of a television broadcast station in which the next program is located includes:

analyzing to obtain, from the first frame of program image of the next program, through image processing, a channel logo of the television broadcast station in which the next program is located, where in an optional implementation manner, a channel logo image is extracted from an upper-left corner of the first frame of program image and then the channel logo that matches the channel logo image is found through an image match algorithm;

matching to obtain corresponding television broadcast station information according to the channel logo;

sending a program list obtaining request including the television broadcast station information to a server; and

receiving the program list returned by the server.

Further, in an optional embodiment, after learning about a television broadcast station corresponding to the channel logo, a program list of the day of the television broadcast station is found through the Internet without using a server.

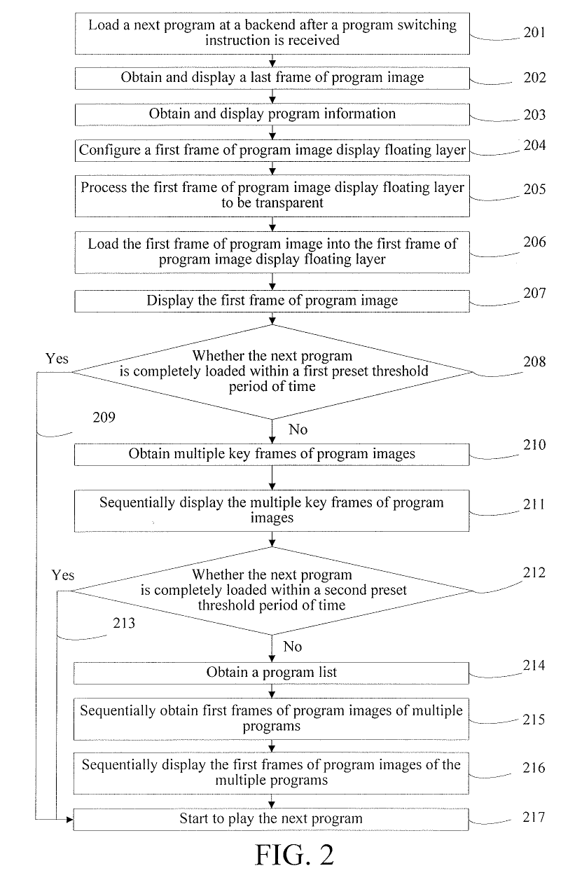

The present disclosure also provides another implementation manner of the method for program switching. As shown in FIG. 2, FIG. 2 a schematic flow chart of a method for program switching according to another embodiment of the present disclosure.

The method for program switching includes the following steps:

In step 201: Load a next program at a backend after a program switching instruction is received.

In step 202: Obtain a last frame of program image at a time when the program switching instruction is received and display the last frame of program image.

In step 203: Obtain program information about the next program and display the program information in the last frame of program image.

In step 204: Configure a first frame of program image display floating layer of the next program on the last frame of program image.

In step 205: Process the first frame of program image display floating layer to be transparent.

In step 206: Load the first frame of program image into the first frame of program image display floating layer.

In step 207: Gradually change transparency of the first frame of program image display floating layer after the first frame of program image is completely loaded and finally display the first frame of program image.

In step 208: Determine whether the next program is completely loaded within a first preset threshold period of time.

In step 209: If the next program is completely loaded within the first preset threshold period of time, enter step 217.

In step 210: If the next program is not completely loaded within the first preset threshold period of time, obtain multiple key frames of program images of the next program.

In step 211: Sequentially display the multiple key frames of program images according to a first preset time interval.

In step 212: Determine whether the next program is completely loaded within a second preset threshold period of time.

In step 213: If the next program is completely loaded within the second preset threshold period of time, enter step 217.

In step 214: If the next program is not completely loaded within the second preset threshold period of time, obtain a program list of a television broadcast station in which the next program is located.

In step 215: Sequentially obtain, according to the program list, first frames of program images of multiple programs of the television broadcast station played after the next program.

In step 216: Sequentially display the first frames of program images of the multiple programs according to a second preset time interval.

In step 217: Start to play the next program at a time when a content of the next program is completely loaded.

As can be seen from the above embodiment, the method for program switching provided by another embodiment of the present disclosure, by gradually displaying a last frame of program image of a program before switching, program information about a next program, and a first frame of program image of the next program during a program switching and loading process, can form visual effects of image freezing during channel switch to display a loading ring (optional) and the program information about the next program, then display the first frame of program image of the next program, and remove the aforementioned images after playing starts, so that a user may not feel boring while waiting in a processing of loading the next program, but rather may obtain some pieces of brief information about the next program during the process of loading the program, and the channel switch experience of the user is improved. Meanwhile, by providing these pieces of brief information to the user timely and effectively, the user may further have a general understanding of whether the user is interested in the program according to these pieces of information, so as to again switch a channel without waiting until the program is loaded.

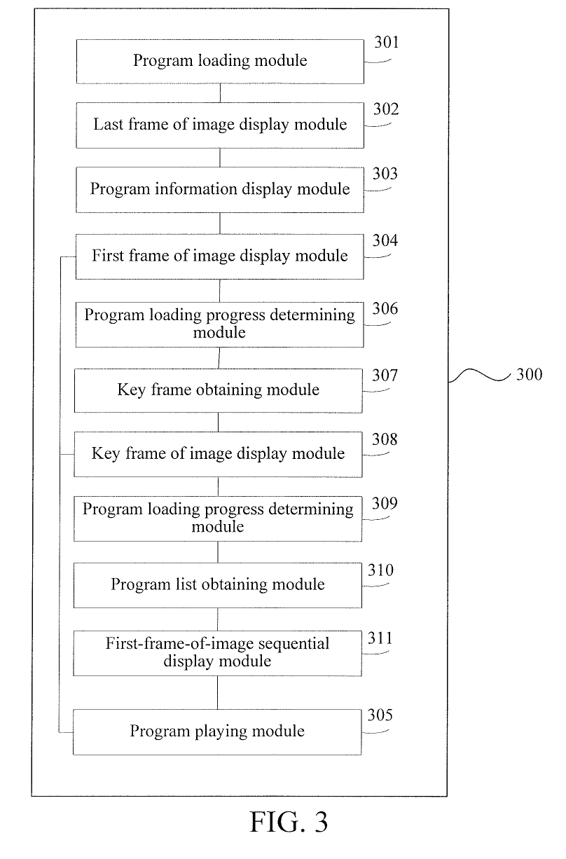

A second aspect of an embodiment of the present disclosure provides an apparatus for program switching 300, capable of providing some pieces of relevant program information to a user during a program switch process so as to alleviate boring feelings of the user. As shown in FIG. 3, FIG. 3 is a structural schematic diagram of modules of an apparatus for program switching 300 according to an embodiment of the present disclosure.

The apparatus for program switching 300 includes: a program loading module 301, a last frame of image display module 302, a program information display module 303, a first frame of image display module 304, and a program playing module 305.

The program loading module 301 is configured to load a next program at a backend after a program switching instruction is received. That is, the process of loading the next program is not displayed to a user and the loading is only performed at the backend.

The last frame of image display module 302 is configured to obtain a last frame of program image at a time when the program switching instruction is received and display the last frame of program image, so as to first display the last frame of program image on a screen in freezing manner after the program switching instruction is received. The last frame of program image indicates a last frame of program image that is currently played at a time point when the program switching instruction is received.

At this time, a loading progress ring may be optionally displayed in the last frame of program image while displaying the last frame of program image, so as to inform the user of that loading of the next program is currently in process, instead of an occurrence of screen crash.

The program information display module 303 is configured to obtain program information about the next program and display the program information in the last frame of program image.

The program information about the next program is further displayed on the screen to provide some information about the next program to the user. The program information includes a program name, a program brief, program start and stop time points, and the like. The program information may be optionally displayed at an upper-right corner of the screen.

The first frame of image display module 304 is configured to obtain a first frame of program image of the next program and switch and display the image as the first frame of program image.

After the first frame of program image of the next program is loaded, the image is switched and displayed as the first frame of program image, so as to provide an image preview of the next program to the user. At this time, the loading progress ring and the program information both may be remained, and only the last frame of program image is replaced.

The program playing module 305 is configured to start to play the next program at a time when a content of the next program is completely loaded.

When starting to play the next program, a playing window may be set to have a first priority, so as to enable the playing window to directly cover the several previously-displayed contents when being started to play. That is, the several previously-displayed contents are not deleted, and the playing window that is set to have the first priority covers and displays on the several previously-displayed contents when being started to play, so that only the playing, window that starts to play the next program can be viewed in the visual effect. Alternatively, the playing window always exists, but has a priority lower than those of the several previously-displayed contents. Therefore, when playing of the next program can be started, the several previously-displayed contents are deleted and the playing window is displayed on the top layer again, so that the playing window can again be viewed in the visual effect and again start to play the next program.

As can be seen from the above content, the apparatus for program switching provided in the embodiment of the present disclosure, by gradually displaying a last frame of program image of a program before switching, program information about a next program, and a first frame of program image of the next program during a program switching and loading process, can form visual effects of image freezing during channel switch to display a loading ring (optional) and the program information about the next program, then display the first frame of program image of the next program, and remove the aforementioned images after playing starts, so that a user may not feel boring while waiting in a processing of loading the next program, but rather may obtain some pieces of brief information about the next program during the process of loading the program, and the channel switch experience of the user is improved. Meanwhile, by providing these pieces of brief information to the user timely and effectively, the user may further have a general understanding of whether the user is interested in the program according to these pieces of information, so as to again switch a channel without waiting until the program is loaded.

To enable displaying of the first frame of program image of the next program not to influence displaying of the last frame of program image, further, in some optional implementation manners, the first frame of image display module 304 is further configured to:

configure a first frame of program image display floating layer of the next program on the last frame of program image;

process the first frame of program image display floating layer to be transparent, where optionally a default background of the first frame of program image is set to be transparent by using GenericDraweeHierarchy of Fresco;

load the first frame of program image into the first frame of program image display floating layer; and

gradually change transparency of the first frame of program image display floating layer after the first frame of program image is completely loaded and finally display the first frame of program image, where optionally, the first frame of program image is set by the AbstractDraweeController to be displayed in a gradually changing manner after being successfully downloaded, to achieve a final effect, and besides, the last frame of program image optionally may further be deleted before gradually displaying the first frame of program image.

Sometimes, under a poor network condition, the program loading process takes a long time. Therefore, in some optional implementation manners, the apparatus for program switching 300 further includes: a program loading progress determining module 306, a key frame obtaining module 307, and a key frame of image display module 308.

The program loading progress determining module 306 is configured to determine whether the next program is completely loaded within a first preset threshold period of time. The first preset threshold period of time may be set by default, or may also be defined by a user, for example, 1 min.

The key frame obtaining module 307 is configured to, if the next program is not completely loaded within the first preset threshold period of time, obtain multiple key frames of program images of the next program. The key frame of program image may be preset by a server and can be obtained as long as a terminal sends a request to the server to obtain data returned by the server. The key frames may be selected and obtained by intercepting program images at equal intervals, or may also be obtained through selection of special frames according to different program contents.

The key frame of image display module 308 is configured to sequentially display the multiple key frames of program images according to a first preset time interval. The first preset time interval indicates a display time interval of the multiple key frames of program images, for example, switching to a next key frame of program image for every 2 s. The first preset time interval may be set by default, or may also be defined by a user.

By setting a first preset threshold period of time, user experience can be improved by sequentially displaying multiple key frames of program images to a user for the user to have a general understanding of a next program, other than only view a first frame of program image of the next program under a poor network condition.

In some other optional implementation manners, the apparatus for program switching 300 further includes: a program loading progress determining module 309, a program list obtaining module 310, and a first-frame-of-image sequential display module 311.

a program loading progress determining module 309, configured to determine whether the next program is completely loaded within a second preset threshold period of time, where the second preset threshold period of time may be set by default, or may also be defined by a user, the second preset threshold period of time may be the same as the first preset threshold period of time, for example, 1 min, and at this time the embodiment is a parallel technical solution of the previous embodiment; certainly, the second preset threshold period of time may also be different from the first preset threshold period of time, for example, 3 min; and when 3 min is reached, the steps in the embodiment are adopted;

a program list obtaining module 310, configured to, if the next program is not completely loaded within the second preset threshold period of time, obtain a program list of a television broadcast station in which the next program is located, where the program list shows a list of programs of the television broadcast station in which the next program is located, and the list includes some pieces of basic information about the programs, for example, playing time and to-be-played content; and

a first-frame-of-image sequential display module 311, configured to sequentially obtain, according to the program list, first frames of program images of multiple programs of the television broadcast station played after the next program, and sequentially display the first frames of program images of the multiple programs according to a second preset time interval.

By setting a second preset threshold period of time, under a poor network condition, in an implementation manner, when the second preset threshold period of time is the same as the first preset threshold period of time, user experience can be improved by sequentially displaying first frames of program images of multiple programs to a user for the user to have a general understanding of a subsequent playing plan of a television broadcast station in which a next program is located, other than only view a first frame of program image of the next program. In another implementation manner, when the second preset threshold period of time is different from the first preset threshold period of time, user experience can be improved by sequentially displaying first frames of program images of multiple programs to a user, after the second preset threshold period of time is reached, for the user to have a general understanding of a subsequent playing plan of a television broadcast station in which a next program is located.

Further, in some optional implementation manners, the program list obtaining module 310 is configured to:

analyze to obtain, from the first frame of program image of the next program, through image processing, a channel logo of the television broadcast station in which the next program is located, where in an optional implementation manner, a channel logo image is extracted from an upper left corner of the first frame of program image and then the channel logo that matches the channel logo image is found through an image match algorithm;

match to obtain corresponding television broadcast station information according to the channel logo;

send a program list obtaining request including the television broadcast station information to a server; and

receive the program list returned by the server.

Further, in an optional embodiment, after learning about a television broadcast station corresponding to the channel logo, a program list of the day of the television broadcast station is found through the Internet without using a server.

A third aspect of an embodiment of the present disclosure further provides program switch equipment, capable of providing some pieces of relevant program information to a user during a program switch process so as to alleviate boring feelings of the user, the program switch equipment including the apparatus for program switching according to any one of the embodiments.

As can be seen from the above embodiments, the computer program equipment provided in the embodiment of the present disclosure, by gradually displaying a last frame of program image of a program before switching, program information about a next program, and a first frame of program image of the next program during a program switching and loading process, can form visual effects of image freezing during channel switch to display the program information about the next program, then display the first frame of program image of the next program, and remove the aforementioned images after playing starts, so that a user may not feel boring while waiting in a processing of loading the next program, but rather may obtain some pieces of brief information about the next program during the process of loading the program, and the channel switch experience of the user is improved. Meanwhile, by providing these pieces of brief information to the user timely and effectively, the user may further have a general understanding of whether the user is interested in the program according to these pieces of information, so as to again switch a channel without waiting until the program is loaded.

A fourth aspect of an embodiment of the present disclosure further provides a computer program product used in combination with program switch equipment, capable of providing some relevant program information to a user during a program switch process to alleviate boring feelings of the user. The computer program product includes a computer-readable storage medium and a built-in computer program mechanism, wherein the program is capable of implementing the method for program switching according to any one of the above embodiments after the program is loaded and executed by a computer.

As can be seen from the above embodiments, the computer program product provided in the embodiment of the present disclosure, by gradually displaying a last frame of program image of a program before switching, program information about a next program, and a first frame of program image of the next program during a program switching and loading process, can form visual effects of image freezing during channel switch to display the program information about the next program, then display the first frame of program image of the next program, and remove the aforementioned images after playing starts, so that a user may not feel boring while waiting in a processing of loading the next program, but rather may obtain some pieces of brief information about the next program during the process of loading the program, and the channel switch experience of the user is improved. Meanwhile, by providing these pieces of brief information to the user timely and effectively, the user may further have a general understanding of whether the user is interested in the program according to these pieces of information, so as to again switch a channel without waiting until the program is loaded.

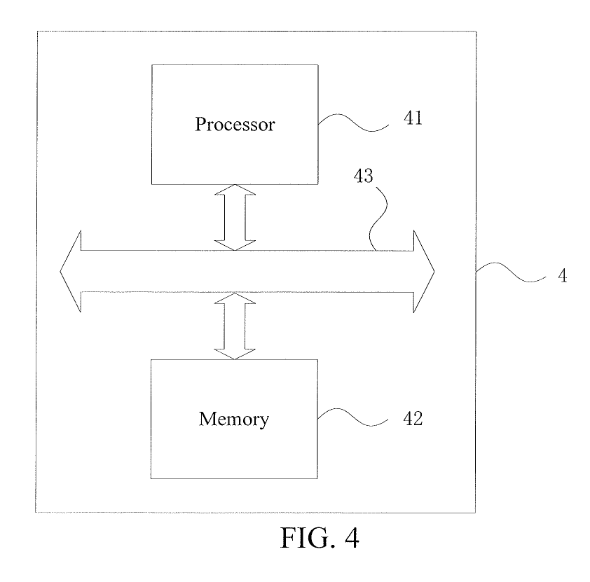

As shown in FIG. 4, FIG. 4 is an embodiment of an electronic device 40, capable of providing some pieces of relevant program information to a user during a program switch process so as to alleviate boring feelings of the user provided in the present disclosure. The electronic device 40 includes: a processor 41, a memory 42, and a bus system 43. The processor 41 and the memory 42 are connected to each other via the bus system 43. The memory 42 is configured to store program instructions, and the processor 41 is configured to execute the program instructions stored in the memory 42, and the processor 41 is configured to:

load a next program at a backend after a program switching instruction is received;

obtain a last frame of program image at a time when the program switching instruction is received and display the last frame of program image;

obtain program information about the next program and display the program information in the last frame of program image;

obtain a first frame of program image of the next program and switch and display the image as the first frame of program image; and

start to play the next program at a time when a content of the next program is completely loaded.

The memory 42 may be a non-transitory computer-readable storage medium, which is configured to store computed executable program instructions. When the program instructions are executed by one or more central processors, for example, the processor 41 may be caused to perform the steps in the above mentioned embodiments of the method, for example, steps 101 to 105 illustrated in FIG. 1, steps 201 to 217 illustrated in FIG. 2. Or, the processor 41 may be caused to perform the modules in the above mentioned embodiments of the electronic device, for example, modules 301 to 311 illustrated in FIG. 3. The computed executable program instructions may also be stored and/or transmitted in any non-transitory computer-readable storage medium, such that these program instructions are used by an instruction executing system, apparatus or device, or used in combination with the instruction executing system, apparatus or device. The instruction executing system, apparatus or device may be, for example, a computer-based system, a system including a processor or another system capable of acquiring program instructions from the instruction executing system, apparatus or device and executing the program instructions. For the purpose of this specification, the “non-transitory computer-readable storage medium” may be any tangible medium including or storing computed executable program instructions. The computed executable program instructions may be used by the instruction executing system, apparatus or device, or used in combination with the executing system, apparatus or device. The non-transitory computer-readable storage medium may include, but not limited to, a magnetic, optical and/or semiconductor memory. Examples of these memorys include a magnetic disk, an optical disc based on CD, DVD and Blu-ray technology, and permanent solid memory (for example, a flash memory, a solid driver and the like).

It should be understood that in the embodiments of the present application, the processor 41 may be a central processing unit (CPU). The processor 41 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 43 may further includes a power bus, a control bus, a state signal bus and the like. However, for clarity of description, various buses are all marked as the bus system 43.

In the embodiments of the present disclosure, the electronic device 40 is not limited to the components and configurations as illustrated in FIG. 4, but may further includes other or additional components having a plurality of configurations.

During the implementation, various steps in the above method and various modules or units in the above electronic device may be implemented by means of an integrated logic circuit in the processor 41 or by means a software. The steps in the method and modules or the units in the electronic device disclosed in the embodiments of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 42. The processor 41 reads the information stored in the memory 42 and performs the steps of the above method in combination with the hardware thereof. For brevity of description, the details are not given herein any further.

As can be seen from the aforesaid embodiments, the electronic device in the present disclosure, by gradually displaying a last frame of program image of a program before switching, program information about a next program, and a first frame of program image of the next program during a program switching and loading process, can form visual effects of image freezing during channel switch to display the program information about the next program, then display the first frame of program image of the next program, and remove the aforementioned images after playing starts, so that a user may not feel boring while waiting in a processing of loading the next program, but rather may obtain some pieces of brief information about the next program during the process of loading the program, and the channel switch experience of the user is improved. Meanwhile, by providing these pieces of brief information to the user timely and effectively, the user may further have a general understanding of whether the user is interested in the program according to these pieces of information, so as to again switch a channel without waiting until the program is loaded.

It should be understood by a person skilled in the art that: discussions in any of the above embodiments are illustrative, and are not intended to imply that the scope of the present disclosure (including the claims) is limited to these examples. The technical features of the above embodiments or different embodiments may also be combined within the concept of the present disclosure. There is a plurality of other changes in different aspects of the present disclosure, as stated above, and the changes are not provided in detail for concise description. Therefore, any modification, equivalent replacement, or improvement made without departing from the spirit and principle of the present disclosure shall fall within the scope of the present disclosure.

What is claimed is:

1. A method for program switching, comprising:
at an electronic device:
loading a next program at a backend after a program switching instruction is received;
obtaining a last frame of program image at a time when the program switching instruction is received;
displaying the last frame of program image;
obtaining program information about the next program;
displaying the program information in the last frame of program image;
obtaining a first frame of program image of the next program;
switching and displaying the image as the first frame of program image; and
starting to play the next program at a time when a content of the next program is completely loaded.

2. The method according to claim 1, wherein the step of obtaining a first frame of program image of the next program and switching and displaying the image as the first frame of program image further comprises:
configuring a first frame of program image display floating layer of the next program on the last frame of program image;
processing the first frame of program image display floating layer to be transparent;
loading the first frame of program image into the first frame of program image display floating layer; and
gradually changing transparency of the first frame of program image display floating layer after the first frame of program image is completely loaded; and
finally displaying the first frame of program image.

3. The method according to claim 1, wherein after the step of obtaining a first frame of program image of the next program and switching and displaying the image as the first frame of program image, further comprises:
determining whether the next program is completely loaded within a first preset threshold period of time;
if the next program is not completely loaded within the first preset threshold period of time, obtaining multiple key frames of program images of the next program; and
sequentially displaying the multiple key frames of program images according to a first preset time interval.

4. The method according to claim 1, wherein after the step of obtaining a first frame of program image of the next program and switching and displaying the image as the first frame of program image, further comprises:
determining whether the next program is completely loaded within a second preset threshold period of time;
if the next program is not completely loaded within the second preset threshold period of time, obtaining a program list of a television broadcast station in which the next program is located;
sequentially obtaining, according to the program list, first frames of program images of multiple programs of the television broadcast station played after the next program; and
sequentially displaying the first frames of program images of the multiple programs according to a second preset time interval.

5. The method according to claim 4, wherein the obtaining a program list of a television broadcast station in which the next program is located further comprises:
analyzing to obtain, from the first frame of program image of the next program, through image processing, a channel logo of the television broadcast station in which the next program is located;
matching to obtain corresponding television broadcast station information according to the channel logo;
sending a program list obtaining request comprising the television broadcast station information to a server; and
receiving the program list returned by the server.

6. An electronic device, comprising:
at least one processor; and
a memory communicably connected with the at least one processor for storing instructions executable by the at least one processor, wherein execution of the instructions by the at least one processor causes the at least one processor to:
load a next program at a backend after a program switching instruction is received;
obtain a last frame of program image at a time when the program switching instruction is received;
display the last frame of program image;
obtain program information about the next program;
display the program information in the last frame of program image;
obtain a first frame of program image of the next program;
switch and display the image as the first frame of program image; and
start to play the next program at a time when a content of the next program is completely loaded.

7. The electronic device according to claim 6, wherein the obtaining a first frame of program image of the next program and switching and displaying the image as the first frame of program image further comprises:
configuring a first frame of program image display floating layer of the next program on the last frame of program image;
processing the first frame of program image display floating layer to be transparent;
loading the first frame of program image into the first frame of program image display floating layer; and
gradually changing transparency of the first frame of program image display floating layer after the first frame of program image is completely loaded; and
finally displaying the first frame of program image.

8. The electronic device according to claim 6, wherein after the step of obtaining a first frame of program image of the next program and switching and displaying the image as the first frame of program image, the execution of the instructions by the at least one processor further causes the at least one processor to:
determine whether the next program is completely loaded within a first preset threshold period of time;
if the next program is not completely loaded within the first preset threshold period of time, obtain multiple key frames of program images of the next program; and
sequentially display the multiple key frames of program images according to a first preset time interval.

9. The electronic device according to claim 6, wherein after the step of obtaining a first frame of program image of the next program and switching and displaying the image as the first frame of program image, the execution of the instructions by the at least one processor further causes the at least one processor to:
determine whether the next program is completely loaded within a second preset threshold period of time;
if the next program is not completely loaded within the second preset threshold period of time, obtain a program list of a television broadcast station in which the next program is located;
sequentially obtain, according to the program list, first frames of program images of multiple programs of the television broadcast station played after the next program; and
sequentially display the first frames of program images of the multiple programs according to a second preset time interval.

10. The electronic device according to claim 9, wherein the obtaining a program list of a television broadcast station in which the next program is located further comprises:
analyzing to obtain, from the first frame of program image of the next program, through image processing, a channel logo of the television broadcast station in which the next program is located;
matching to obtain corresponding television broadcast station information according to the channel logo;
sending a program list obtaining request comprising the television broadcast station information to a server; and
receiving the program list returned by the server.

11. A non-transitory computer-readable storage medium storing executable instructions, wherein when executed by an electronic device, causes the electronic device to:
load a next program at a backend after a program switching instruction is received;
obtain a last frame of program image at a time when the program switching instruction is received;
display the last frame of program image;
obtain program information about the next program;
display the program information in the last frame of program image;
obtain a first frame of program image of the next program;
switch and display the image as the first frame of program image; and
start to play the next program at a time when a content of the next program is completely loaded.

12. The non-transitory computer-readable storage medium according to claim 11, wherein the obtaining a first frame of program image of the next program and switching and displaying the image as the first frame of program image further comprises:
configuring a first frame of program image display floating layer of the next program on the last frame of program image;
processing the first frame of program image display floating layer to be transparent;
loading the first frame of program image into the first frame of program image display floating layer; and
gradually changing transparency of the first frame of program image display floating layer after the first frame of program image is completely loaded; and
finally displaying the first frame of program image.

13. The non-transitory computer-readable storage medium according to claim 11, wherein after the step of obtaining a first frame of program image of the next program and switching and displaying the image as the first frame of program image, the electronic device is further caused to:
determine whether the next program is completely loaded within a first preset threshold period of time;
if the next program is not completely loaded within the first preset threshold period of time, obtain multiple key frames of program images of the next program; and
sequentially display the multiple key frames of program images according to a first preset time interval.

14. The non-transitory computer-readable storage medium according to claim 11, wherein after the step of obtaining a first frame of program image of the next program and switching and displaying the image as the first frame of program image, the electronic device is further caused to:
determine whether the next program is completely loaded within a second preset threshold period of time;
if the next program is not completely loaded within the second preset threshold period of time, obtain a program list of a television broadcast station in which the next program is located;
sequentially obtain, according to the program list, first frames of program images of multiple programs of the television broadcast station played after the next program; and
sequentially display the first frames of program images of the multiple programs according to a second preset time interval.

15. The non-transitory computer-readable storage medium according to claim 14, wherein the obtaining a program list of a television broadcast station in which the next program is located further comprises:
analyzing to obtain, from the first frame of program image of the next program, through image processing, a channel logo of the television broadcast station in which the next program is located;
matching to obtain corresponding television broadcast station information according to the channel logo;
sending a program list obtaining request comprising the television broadcast station information to a server; and
receiving the program list returned by the server.
